(19) United States
(12) Patent Application Publication
(10) Pub. No.: US 2007/0146648 A1
(43) Pub. Date: Jun. 28, 2007

(54) Projector Using a Motor for Driving an Iris Installed Between a Light Source and a Digital Micro-Mirror Device

(76) Inventor: Chia-Hsiung Peng, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 11/616,014

(22) Filed: Dec. 25, 2006

(30) Foreign Application Priority Data
Dec. 26, 2005 (TW) 094146517

(51) Int. Cl. G03B 21/14

(52) U.S. Cl. 353/82

(57) ABSTRACT

A projector includes a light source, a digital micro-mirror device, and an iris installed between the light source and the digital micro-mirror device. The iris includes a frame, a fixed plate fixed on the frame, a guiding rod fixed to the frame in a rotatable manner, a moveable plate having one end connected the guiding rod for moving along the guiding rod where an opening is formed between the moveable plate and the fixed plate, and a motor for rotating the guiding rod in order to move the moveable plate. Therefore a user is not required to adjust the first iris manually.

### BACKGROUND OF THE INVENTION

1. Field of the Invention

The present invention relates to a projector, and more particularly, to a projector utilizing a motor for driving an iris installed between a light source and a digital micro-mirror device.

2. Description of the Prior Art

To help maximize the participant's understanding of the contents of a presentation, a projector is commonly utilized to display the contents or graphs of the presentation on a screen. Thereby the participants can view the data on the screen and better relate to the contents of the presentation. This creates more interaction and understanding between the presenter and the audience. As technology advances, the projector has become more common and has even become more affordable for home use. Now the projector is often combined with sound and visual equipment, such as high-powered audio sound systems, and high-definition quality DVD players so that a user can enjoy the visual and listening experience of watching big screen images (like in a cinema) at home.

Please refer to FIG. 1. FIG. 1 illustrates an internal architecture diagram of a conventional projector 100. The projector 100 includes a light source 110, a plurality of lenses 112, a reflector 114, a digital micro-mirror device 116, and a projector 118. Light transmitted from the light source 110 passes through or reflects on the above-mentioned components sequentially along a light path 124, and the image to be displayed by the projector 100 is then projected. In general, a section from the light source 110 to the digital micro-mirror device 116 is known as a lamp house 120 of the projector 110. In order to control the image contrast of the projector 100, the projector 100 further includes an iris 130 installed between the digital micro-mirror device 116 and the projector lens 118 for blocking a portion of the light transmitted from the light source 110, and movement of the iris 130 is being driven by a motor. The user can also utilize a remote controller or buttons on the projector 100 to control and adjust picture contrast. Please refer to FIG. 2. FIG. 2 illustrates a diagram of a manual iris 140 of the lamp house 120 of FIG. 1. In this prior art, the lamp house 120 further includes the manual iris 140 such that the user can rotate a douser 144 of the manual iris 140 by controlling a rod 142 to block a portion of projected light transmitted from the light source to further adjust the image contrast of the projector 100.

However, when the user is watching the projected picture, the user is usually a short distance away from the projector 100. To make said adjustments, the user must walk towards the projector 100 in order to adjust the manual iris 140 manually. When the user is adjusting the iris 130 and the iris 140, the light within the projection range in accordance to the light path 124 is magnified in a predetermined ratio, therefore the movement of the iris 130 and the iris 140 is ratio related, thus the user usually adjusts the iris 130 and the iris 140 repeatedly to achieve a most suitable image contrast. The prior art causes inconvenience and inaccuracy to the user such as adjusting the manual iris 140 manually and not providing the ability to simultaneously adjust the movement of the iris 130 and the manual iris 140 in a predetermined ratio manner.

### SUMMARY OF THE INVENTION

The claimed invention discloses a projector comprising a light source; a digital micro-mirror device; and a first iris installed between the light source and the digital micro-mirror device. The first iris comprises a frame; a fixed plate fixed on the frame; a guiding rod fixed to the frame in a rotatable manner; a moveable plate having one end connected the guiding rod for moving along the guiding rod wherein an opening is formed between the fixed plate and the moveable plate; and a motor for rotating the guiding rod in order to move the moveable plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an internal architecture diagram of a conventional projector.

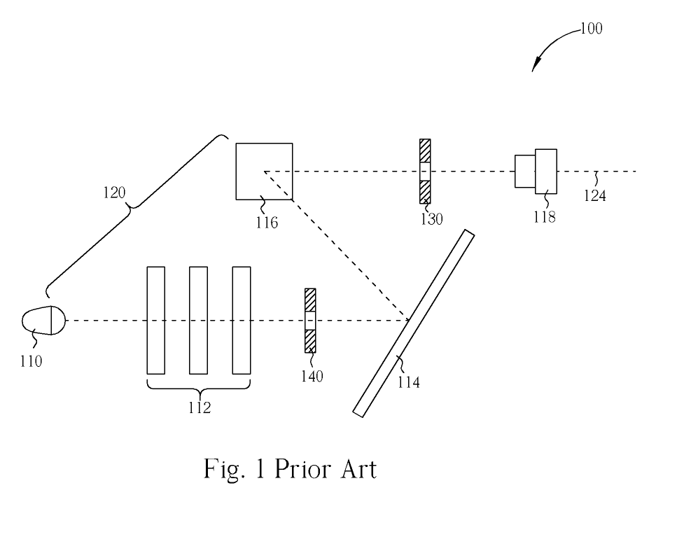

FIG. 2 illustrates a diagram of a manual iris of the lamp house of FIG. 1.

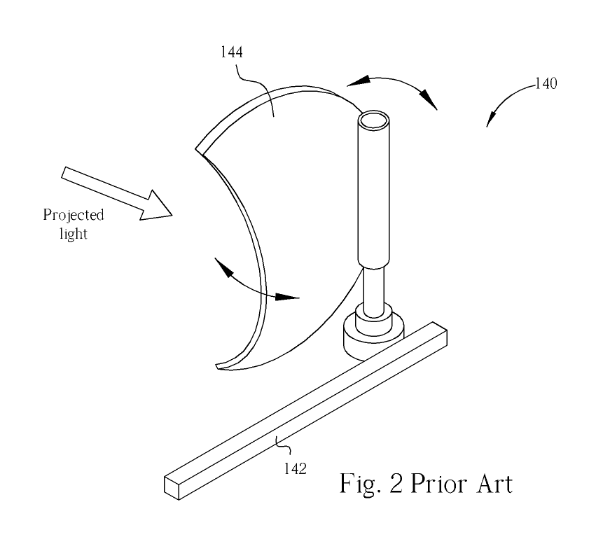

FIG. 3 illustrates an internal architecture diagram of a projector according to the present invention.

FIG. 4 illustrates a diagram of a first iris in FIG. 3 being installed between a light source and a reflector.

FIG. 5 illustrates a diagram of the projector of FIG. 3 controlling picture contrast.

### DETAILED DESCRIPTION

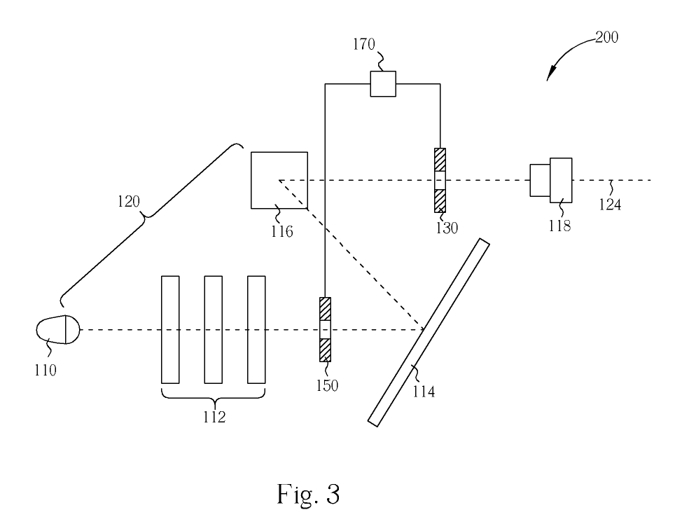

Please refer to FIG. 3. FIG. 3 illustrates an internal architecture diagram of a projector 200 according to the present invention. The projector 200 includes a light source 110, a plurality of lenses 112, a reflector 114, a digital micro-mirror device 116, and a projector lens 118, wherein light transmitted from the light source 110 passes through or reflects on the above-mentioned components sequentially along a light path 124, and a picture to be displayed by the projector 100 is projected. Furthermore, a second iris 130 of the projector 200 is installed between the digital micro-mirror device 116 and the projector lens 118, a first iris 150 is installed between the light source 110 and the reflector 114. The projector 200 further includes a driving chip 170 coupled to the second iris 130 and the first iris 150 for controlling the operation of the second iris 130 and the first iris 150. A motor is utilized to drive the first iris 150 of a lamp house 120 of the present invention, therefore a user is not required to adjust the first iris manually. Furthermore, the driving chip 170 simultaneously controls the operations of the second iris 130 and the first iris 150 according to a predetermined ratio, hence the user can accurately adjust picture contrast of the projector 200.

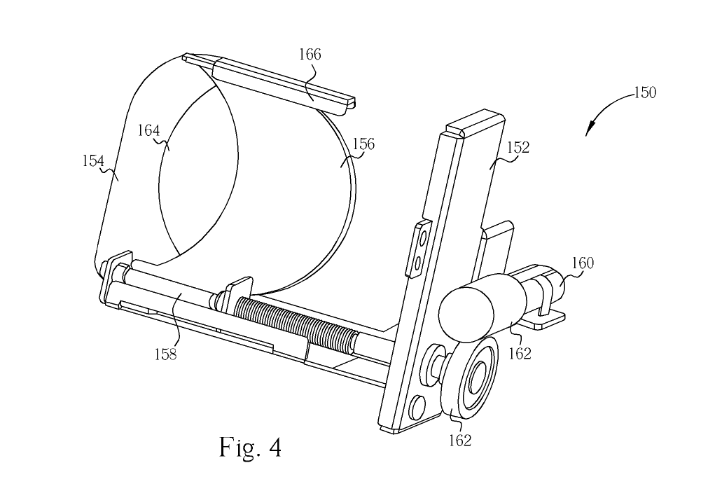

Please refer to FIG. 4. FIG. 4 illustrates a diagram of a first iris 150 being installed between a light source 110 and a reflector 114. The first iris 150 includes a frame 152, a fixed plate 153 fixed on the frame 152, a guiding rod 158 fixed to the frame in a rotatable manner, a moveable plate 156 where one end is connected to the guiding rod 158 for moving along the guiding rod 158, and a motor 160 for rotating the guiding rod 158 in order to move the moveable plate 156. The fixed plate 154 of the first iris 150 of the present invention is fixed, and the fixed plate 154 with the moveable plate 156 blocks a portion of the light from the light source 110. Furthermore, a guideway 166 on the fixed plate 154 limits another end of the moveable plate 156 to prevent the moveable plate 156 from rotating together with the guiding rod 158 when the guiding rod 158 rotates, however the present invention can also utilize the architecture of the frame 152 or shape of the moveable plate 156 to prevent the moveable plate 156 from rotating together with the guiding rod 158. An end of the moveable plate 156 is coupled to the guiding rod 158, and there is a screw thread on the guiding rod 158, so when the motor 160 rotates, the guiding rod 158 will also rotate as well, the screw thread on the guiding rod 158 in accordance to the rotation of the guiding rod will move the moveable plate 156. The movement of the moveable plate 156 will change size of an opening 164 between the moveable plate 156 and the fixed plate 154, a smaller size of the opening 164 corresponds to more light being blocked by the first iris 150, whereas a bigger the size of the opening 164 corresponds to less light being blocked by the first iris 150 and eventually with the size of the opening 164 being big enough all available light can pass through.

The first iris 150 further includes a plurality of gears 162 coupled between the motor 160 and the guiding rod 158. The gear 162 is utilized for transmitting a force generated from the rotation of the motor 160 to the guiding rod 158 to rotate the guiding rod 158. Another function of the gear 162 is to provide a transfer ratio such that a revolution of the guiding rod 158 is equal to the multiplication of a revolution of the motor 106 and the transfer ratio in order to achieve a designer's requirement. The motor 160 can be a step motor, as the step motor is being driven pulse signals, therefore the revolution of the step motor can be controlled by the pulse signals generated by a chip or a circuit such as the driving chip 170 of FIG. 3. However, in another embodiment of the present invention, the motor 160 can also be directly connected to the guiding rod 158 to rotate the guiding rod 158, thus the gear 162 is not utilized. Furthermore, in a more preferred embodiment, a movement direction of the moveable plate 156 is a direction perpendicular to a traveling direction of the light transmitted by the light source 110, thus the light blocked by the first iris 150 will be reflected back to the light source 110 or will be absorbed by the first iris 150, the light is not reflected to other directions because that can cause a light interference problem. However, even if the movement direction of the moveable plate 156 is not perpendicular to the traveling direction of the light transmitted by the light source 110, the motor 160 can still control the size of the opening 164 of the first iris 150, and the above-mentioned still falls within the metes and bounds of the present invention.

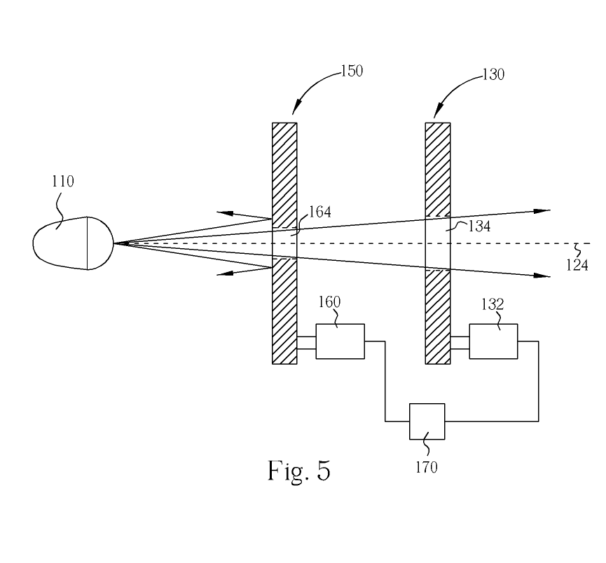

Please refer to FIG. 5. FIG. 5 illustrates a diagram of the projector 200 of FIG. 3 controlling picture contrast. The picture contrast and projection light of the projector 200 are both related to the light quantity that passes through the first and second iris 150,130. Therefore, size of the openings 134,164 of the irises 130,150 also determines a contrast degree of the projected picture. The present invention utilizes the driving chip 170 to simultaneously control the operations of the second iris 130 and the first iris 150, the present invention also utilizes the driving chip 170 to simultaneously control the sizes of the openings 134,164 of the second iris 130 and the first iris 150. As shown in FIG. 5, the light transmitted from the light source 110 traveling along the light path 124 magnifies its projection range in a predetermined ratio. Note that the distance traveled by the light along the light path 124 is shorter at the first iris 150 of the lamp house 120, therefore the projection range of the light at the first iris 150 is smaller, and because the distance traveled by the light along the light path 124 is longer at the second iris 130 between the digital micro-mirror device 116 and the projector lens 118, therefore the projection range of the light at the second iris 130 is greater. Thus when the projector 200 adjusts the iris 130, 150, the projector 200 is required to adjust the sizes of the openings 134, 164 of the irises 130, 150 according to the predetermined ratio, if either the second iris 130 or the first iris 150 does not follow the predetermined ratio to adjust the sizes of the openings 134, 164, then either the first iris 150 or the second iris 130 will block extra light, or either the first iris 150 or the second iris 130 will block light that is less than required, thus the picture contrast of the projector 200 is affected. For example, if the predetermined ratio is 2:3, and when a surface area of the opening 134 of the second iris 130 is being shrunk to 3 mm², a surface area of the opening 136 of the first iris 150 must also be shrunk to 2 mm²; on the contrary, when the surface area of the opening 134 of the second iris 130 is being enlarged to 3 mm², the surface area of the opening 136 of the first iris 150 must also be enlarged to 2 mm². Therefore, when the driving chip 170 simultaneously controls the operation of the first iris 150 and the second iris 130, the driving chip 170 is required to simultaneously control the operations of the irises 130, 150 according to the predetermined ratio. Furthermore, if a motor 132 and the motor 160 of the first iris 130 and the second iris 150 is each a step motor, then the driving chip 170 is only required to provide pulse signals of the predetermined ratio to the motors 132, 160 so that the motors 132, 160 can move the irises 130, 150 according to the pulse signals of the predetermined ratio.

In the embodiment of FIG. 5, the second iris 130 between the digital micro-mirror device 116 and the projector lens 118 is based on the design of the first iris 150 of FIG. 4, however the second iris 130 is not required to follow the design mentioned, a conventional iris can also be utilized provided that the sizes of the openings 134, 164 of the second iris 130 and the first iris 150 are simultaneously controlled according to a predetermined ratio and light quantity of projected light that passes through the second iris 130 and the first iris 150 is simultaneously controlling according to a predetermined ratio. All the above-mentioned are included or within the metes and bounds of the present invention.

19 In conclusion, the present invention provides a projector 200, which includes a first iris 150 that is driven by a motor 160 installed between a light source 110 and a digital micro-mirror device 116, and the present invention can utilize a driving chip 170 to provide a predetermined ratio pulse to simultaneously control operations of the first iris 150 and a second iris 130, in this way a user is only required to utilize a remote controller or buttons on the projector 200 to transmit signals to the driving chip 170, hence the irises 130, 150 can be simultaneously controlled to further adjust picture contrast.

In comparison to the prior art, the first iris 150 of the present invention installed between the light source 110 and the digital micro-mirror device 116 is driven by the motor 160, hence the user is not required to adjust the first iris 150 manually. The present invention further provides a method of simultaneously controlling operations the first iris 150 and the second iris 130 according to a predetermined ratio to accurately adjust picture contrast of the projector 200.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector comprising:
a light source;
a digital micro-mirror device; and
a first iris installed between the light source and the digital micro-mirror device, the first iris comprising:
a frame;
a fixed plate fixed on the frame;
a guiding rod fixed to the frame in a rotatable manner;
a moveable plate having one end connected to the guiding rod for moving along the guiding rod wherein an opening is formed between the fixed plate and the moveable plate; and
a motor for rotating the guiding rod in order to move the moveable plate.

2. The projector of claim 1 further comprising: a projector lens;
a second iris installed between the projector lens and the digital micro-mirror device; and
a driving chip for controlling simultaneously the first iris and the second iris.

3. The projector of claim 2 wherein the driving chip is utilized for controlling simultaneously size of an opening formed on the first iris and size of an opening formed on the second iris according to a predetermined ratio.

4. The projector of claim 1 wherein the first iris further comprises a gear coupled between the motor and the guiding rod.

5. The projector of claim 1 wherein the motor is a step motor.

6. The projector of claim 1 wherein the moveable plate is moveable in a direction perpendicular to a traveling direction of light transmitted by the light source.

7. A method of controlling an image contrast of a projector, the method comprising:
positioning a first iris between a light source of the projector and a digital micro-mirror device;
positioning a second iris between a projector lens and the digital micro-mirror device; and simultaneously controlling size of an opening formed on the first iris and size of an
opening formed on the second iris according to a predetermined ratio.

8. The method of claim 7 wherein simultaneously controlling the size of the opening formed on the first iris and the size of the opening formed on the second iris according to the predetermined ratio is simultaneously controlling a first motor to adjust the opening formed on the first iris and controlling a second motor to adjust the opening formed on the second iris according to the predetermined ratio.

9. The method of claim 8 wherein simultaneously controlling the first motor to adjust the opening formed on the first iris and controlling the second motor to adjust the opening formed on the second iris according to the predetermined ratio is simultaneously providing pulses to the first motor to adjust the opening formed on the first iris and providing pulses to the second motor to adjust the opening formed on the second iris according to the predetermined ratio.
